(19) United States
(12) Patent Application Publication
(10) Pub. No.: US 2011/0038553 A1
(43) Pub. Date: Feb. 17, 2011

(54) PICTURE IMAGE FILE TRANSMISSION SYSTEM AND METHOD THEREOF

(76) Inventor: Chien-Tang TSENG, Taipei (TW)

Correspondence Address: DUANE MORRIS LLP - Philadelphia;IP DEPARTMENT, 30 SOUTH 17TH STREET, PHILADELPHIA, PA, 19103-4196, US

(21) Appl. No.: 12/769,183

(22) Filed: Apr. 28, 2010

(30) Foreign Application Priority Data
Aug. 17, 2009 (CN) 098127644

(51) Int. Cl. G06K 9/36

(52) U.S. Cl. 382/232

(57) ABSTRACT

A method for transferring a picture image file from a transfer end to a receive end, comprising the following steps of: providing a first set of blocks at the transfer end; dividing the picture image file into a plurality of blocks at the transfer end; comparing the plurality of blocks with a first set of blocks to generate a correlation parameter for each block; determining whether the correlation parameter for each block is not less than a correlation threshold, and removing each of the blocks with the correlation parameter not less than the correlation threshold; generating a reconstruction information which records the linkage relationship between each of the plurality of blocks; transferring the plurality of blocks those are not removed and the reconstruction information to the receive end; and reconstructing the plurality of blocks into the picture image file based on the reconstruction information and a second set of blocks.

### BACKGROUND OF THE INVENTION

1. Field of the Invention

The present invention relates to the technology of file transmissions; in particular, the present invention relates to a picture image file transmission system and a method thereof for the bandwidth saving.

2. Description of Related Art

When people send pictures to share with their remote friends, it is usual that the contents shown on the pictures to be shared are mutually related to a certain extend, such as the theme of the image, background thereof (mountain, sky, river, a table with a target object placed thereon), brightness of the scene, location of the scene, along the same voyage course, or otherwise some physical features intrinsic to the lens installed on the camera itself. As shown in FIG. 1, a conventional picture transmission operation mostly concerns, at first, compressing the picture to be sent, transferring to a receive end through a network, and after reception by the receive end via networks, decompressing the received data at the receive end thereby achieving the objective of picture sharing. However, during the aforementioned picture sharing process, the transmission of each picture is mutually independent, even for two pictures having the identical contents; such a compression/transfer/decompression cycle still needs to repeat itself all the time, unable to provide any advantage in the feature of reuse.

To improve the drawback found in prior art, the present invention herein provides a picture image file transmission system and a method thereof for the bandwidth saving, which allows to, upon sharing the picture image file located in a directory with a remote party, perform compressions by means of the present invention so as to advantageously reuse the correlation of the picture contents.

### SUMMARY OF THE INVENTION

With regards to the above-said drawbacks in prior art, one objective of the present invention is to provide a picture image file transmission system and a method thereof which allows to utilize the existing picture image data at the receive end as the base for removal of highly correlated blocks in the picture image file to be transferred, accordingly reducing the required bandwidth for transmissions by reusing the correlation in the contents of the picture image.

One objective of the present invention is to provide a picture image file transmission system and a method thereof which allows to, in terms of multiple independent picture image files mutually having no time sequence relationships, reduce the required bandwidth for transmissions by removing highly correlated blocks in each block of the picture image files.

According to anther objective of the present invention, a method of picture image file transmission is provided for transferring an independent picture image file from a transfer end to a receive end, comprising the following steps of: initially, providing a first set of blocks at the transfer end and providing a second set of blocks at the receive end; dividing the independent picture image file into a plurality of blocks at the transfer end; then comparing such plurality of blocks with the first set of blocks at the transfer end to accordingly generate a correlation parameter for each of the plurality of blocks; next, determining at the transfer end whether the correlation parameter for each of the plurality of blocks is not less than the correlation threshold and removing each of the blocks with the correlation parameter not less than the correlation threshold; subsequently, generating a reconstruction information which records the linkage relationship between each of the plurality of blocks at the transfer end; and then transferring the plurality of blocks those are not removed and the reconstruction information to the receive end having the second set of blocks, in which the first set of blocks and the second set of blocks have the same block data; finally, reconstructing the plurality of blocks into the independent picture image file based on the reconstruction information and the second set of blocks at the receive end.

Herein the aforementioned independent picture image file is preferably a compressed file.

Herein, in order to maintain the consistency between the first set of blocks and the second set of blocks, the transfer end and the receive end may store the plurality of blocks whose correlation parameter is less than the correlation threshold respectively into the first set of blocks and the second set of blocks, so as to enhance the reusability of the picture image data in subsequent processes by means of continuous data updates at the transfer end and the receive end.

According to yet another objective of the present invention, a method of picture image file transmission is provided for transferring multiple independent picture image files from a transfer end to a receive end, comprising the following steps of: initially, dividing the multiple independent picture image files into a plurality of blocks at the transfer end; then comparing such plurality of blocks at the transfer end to generate the correlation parameter for each of the plurality of blocks; next, determining at the transfer end whether the correlation parameter for each of the plurality of blocks is not less than the correlation threshold, and removing each of the blocks with the correlation parameter not less than the correlation threshold; subsequently, generating a reconstruction information which records the linkage relationship between each of the plurality of blocks at the transfer end; and then transferring the plurality of blocks those are not removed and the reconstruction information to the receive end; finally, reconstructing the plurality of blocks into the multiple independent picture image files based on the reconstruction information at the receive end.

Herein the aforementioned multiple independent picture image files may be compressed files, and time sequence relationships between such multiple independent picture image files are not required.

According to still yet another objective of the present invention, a picture image file transmission system is provided, comprising a transfer end and a receive end. The transfer end comprises a first database, a first image process module, a compare module, a process module and a transfer module. The first database may be used to store the first set of blocks and the correlation threshold. The first image process module may be used to divide the independent picture image file into a plurality of blocks, wherein the independent picture image file may be a compressed file. The compare module may be used to compare the plurality of blocks with the first set of blocks to accordingly generate the correlation parameter for each of the plurality of blocks. The process module can determine whether the correlation parameter for each of the plurality of blocks is not less than the correlation threshold and remove each of the blocks whose correlation parameter is not less than the correlation threshold, and accordingly generate the reconstruction information which records the linkage relationship between each of the plurality of blocks. The transfer module may be used to transfer the plurality of blocks and the reconstruction information. The receive end comprises a second database, a receive module and a second image process module. The second database may be used to store the second set of blocks, in which the first set of blocks and the second set of blocks have the same block data. The receive module may be used to receive the plurality of blocks those are not removed and the reconstruction information. The second image process module may reconstruct the plurality of blocks into the independent picture image file based on the reconstruction information and the second set of blocks.

Herein, in order to maintain the consistency between the first set of blocks and the second set of blocks, the transfer end and the receive end may store the block whose correlation parameter is less than the correlation threshold respectively into the first set of blocks and the second set of blocks, so as to enhance the reusability of the picture image data in subsequent processes by means of continuous data updates at the transfer end and the receive end.

In addition, the present invention further provides a picture image file transmission system comprising a transfer and a receive end. The transfer end comprises a first database, a first image process module, a compare module, a process module and a transfer module. The first database may be used to store the correlation threshold. The first image process module may be used to divide multiple independent picture image files into a plurality of blocks, wherein the multiple independent picture image file may be compressed files, and the time sequence relationship between such multiple independent picture image files are not required. The compare module may be used to compare the plurality of blocks to accordingly generate the correlation parameter for each of the plurality of blocks. The process module can determine whether a correlation parameter for each of the plurality of blocks is not less than a correlation threshold and remove each of the blocks whose correlation parameter is not less than the correlation threshold, and accordingly generate the reconstruction information which records the linkage relationship between each of the plurality of blocks. The transfer module may be used to transfer the plurality of blocks and the reconstruction information. The receive end comprises a receive module and a second image process module. The receive module may be used to receive the plurality of blocks and the reconstruction information. The second image process module may reconstruct the plurality of blocks into the multiple independent picture image files based on the reconstruction information.

In summary of the descriptions set forth hereinbefore, the picture image file transmission system and a method thereof according to the present invention provides one or more of the following advantages:

(1) as the transfer end and the receive end each individually maintains a copy of the same set of blocks, upon transferring the picture image file and then comparing data in the divided blocks with the set of blocks, it is only required to transfer the blocks of lower correlation thereby saving the transmission bandwidth;

(2) in case of transferring multiple picture image files and then comparing the divided multiple blocks, it is only required to transfer the blocks of lower correlation thereby saving the transmission bandwidth.

### BRIEF DESCRIPTION OF THE DRAWINGS

FIG. 1 is a diagram for a picture image file transmission architecture of prior art;

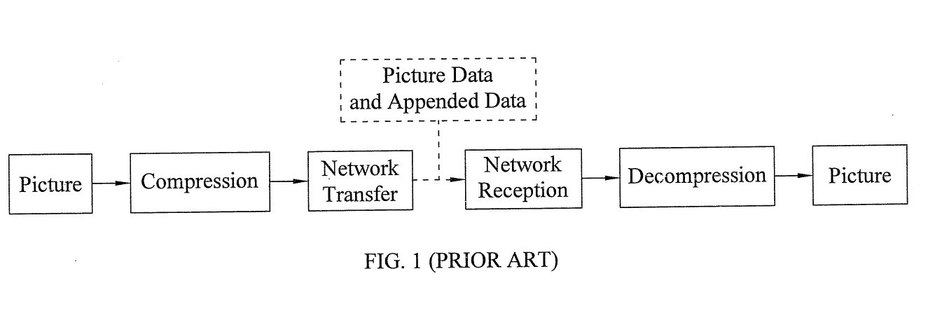

FIG. 2 is a flowchart for the method of picture image file transmission according to the present invention;

FIG. 3 is a flowchart for the method of picture image file transmission according to the present invention; and

FIG. 4 is a diagram for the picture image file transmission system according to the present invention.

### DETAILED DESCRIPTION OF THE PREFERRED EMBODIMENTS

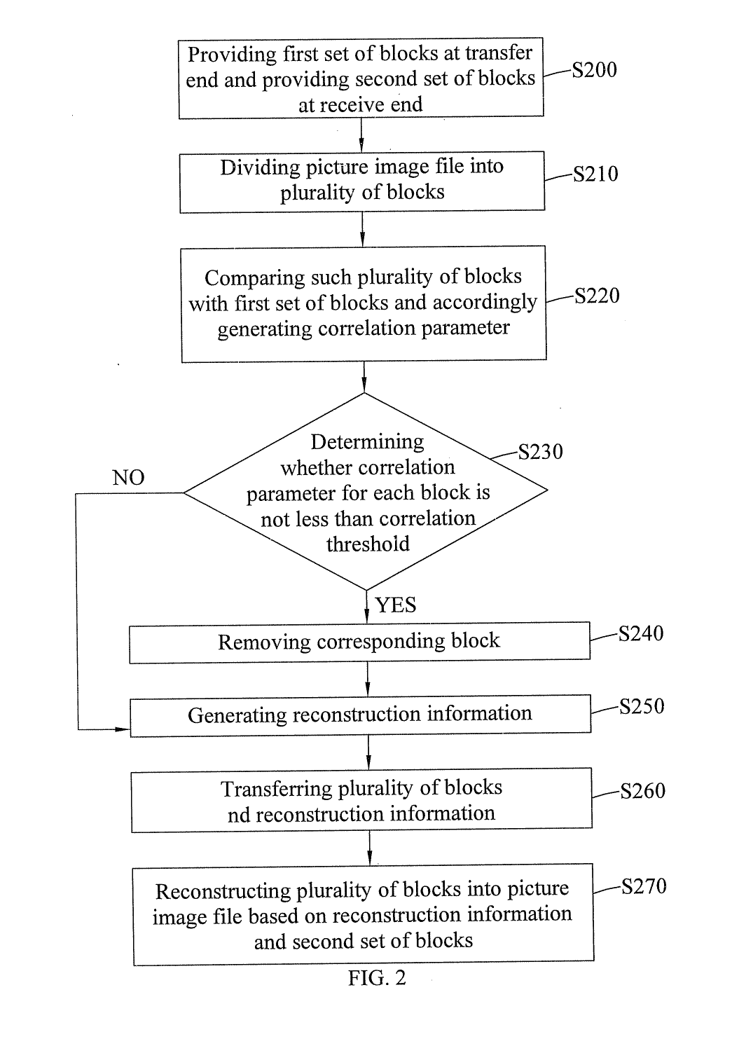

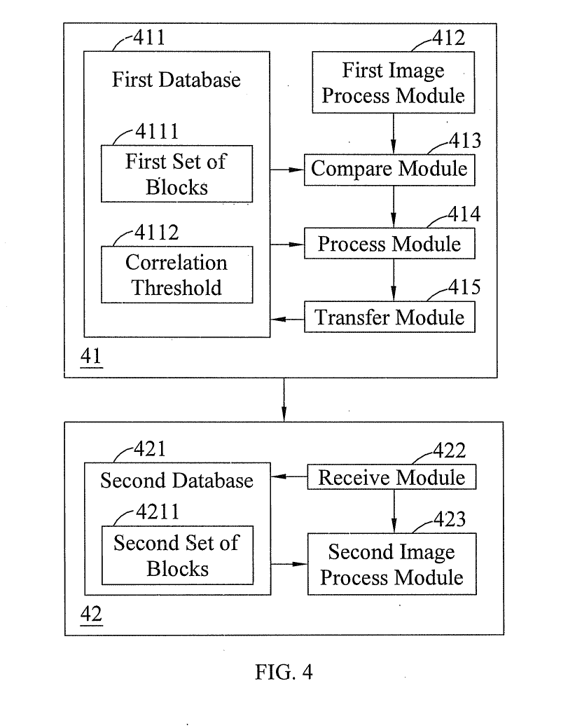

The picture image file transmission system and the method thereof according to the present invention allows to transfer the picture image file from a transfer end to a receive end, and under such an application configuration, the transfer end may make effective reuse of the data based on the block data that the receive end already has, so as to reduce the data transmission amount by means of omitting the block data already existing at the receive end. The transfer end and the receive end each maintains a copy of the same block set data (respectively referred as the first set of blocks and the second set of blocks). In picture image file transmissions, the transfer end compares the block data of the picture image file with the first set of blocks and transfers the block data of low correlation to the receive end, wherein the correlation of the block may be differently defined in accordance with practical applications, such as color value of the block, brightness of the block or else other attributes applicable for differentiating block data and the like, and the level of the correlation (correlation threshold) may be also variably set depending on actual usage. Afterward, the receive end receives the block data of low correlation and reconstructs the received block data into the picture image file based on the second set of blocks. The present configuration is applicable for transferring one or more independent picture image files from the transfer end to the receive end, and the time sequence relationship between such independent picture image files are not required. The method and the system described as above will now be further illustrated in details hereunder in conjunction with FIGS. 2 and 4.

Refer to FIG. 2, wherein a flowchart for the method of picture image file transmission according to the present invention is shown. In the Figure, the present method comprises the following steps: at STEP S200, providing a first set of blocks at the transfer end and providing a second set of blocks at the receive end, in which the first set of blocks and the second set of blocks are preferably the same block data; then, at STEP S210, dividing an independent picture image file into a plurality of blocks at the transfer end, in which the independent picture image file may be a compressed file; e.g., a compressed file of JPEG format; at STEP S220, comparing each block with the first set of blocks at the transfer end to generate the correlation parameter for each block; at STEP S230, determining at the transfer end whether the correlation parameter of each block is not less than the correlation threshold; in case of affirmative determination, performing STEP S240 and removing the corresponding block, in which the correlation parameter is not less than the correlation threshold; following this, at STEP S250, generating a reconstruction information recording the linkage relationship between each of the plurality of blocks at the transfer end; at STEP S260, transferring the plurality of blocks and the reconstruction information to the receive end, in which the receive end has the second set of blocks, wherein the first set of block and the second set of blocks have the same block data; finally, at STEP S270, reconstructing the plurality of blocks into the independent picture image file based on the reconstruction information and the second set of blocks.

Refer next to FIG. 4, wherein a diagram for the picture image file transmission system according to the present invention is shown. In the Figure, the picture image file transmission system as depicted comprises a transfer end 41 and a receive end 42. The transfer end 41 comprises a first database 411, a first image process module 412, a compare module 413, a process module 414 and a transfer module 415. The first database 411 can be used to store the first set of blocks 4111 and the correlation threshold 4112. The first image process module 412 can be used to divide the independent picture image file into a plurality of blocks, wherein the independent picture image file may be a compressed file. The compare module 413 can be used to compare the plurality of blocks with the first set of blocks 4111, and accordingly generate the correlation parameter for each block. The process module 414 can determine whether the correlation parameter for each of the plurality of blocks is not less than the correlation threshold and remove the blocks having the correlation parameter not less than the correlation threshold 4112 from the plurality of blocks and accordingly generate a reconstruction information recording the linkage relationship between each of the plurality of blocks. The transfer module 415 can be used to transfer the plurality of blocks and the reconstruction information. The receive end 42 comprises a second database 421, a receive module 422 and a second image process module 423. The second database 421 can be used to store the second set of blocks 4211, in which the first set of blocks 4111 and the second set of blocks 4211 have the same block data. The receive module 422 can be used to receive the plurality of block those are not removed and the reconstruction information. The second image process module 423 can reconstruct the plurality of blocks into the independent picture image file based on the reconstruction information and the second set of blocks 4211.

Herein, in order to maintain the consistency between the first set of blocks 4111 and the second set of blocks 4211, the transfer end 41 and the receive end 42 may store the block whose correlation parameter is less than the correlation threshold 4112 respectively into the first set of blocks 4111 and the second set of blocks 4211, so as to enhance the reusability of the picture image data in subsequent processes by means of continuous data updates at the transfer end 41 and the receive end 42.

Herein, before transferring the plurality of blocks those are not removed and the reconstruction information to the receive end 42, each of the blocks those are not removed is respectively compressed, each with a compression process transferred to the receive end 42, and the receive end 42 receives information of the compression process and performs decompressions on each of the compressed blocks in accordance with the compression process respectively.

At the step of block comparing (or otherwise, the compare module 413) it is possible to determine the correlation parameter based on the brightness histogram for the plurality of blocks, and execute fast indexation on the brightness histogram for the block in terms of mean value of brightness, brightness variant or brightness variance.

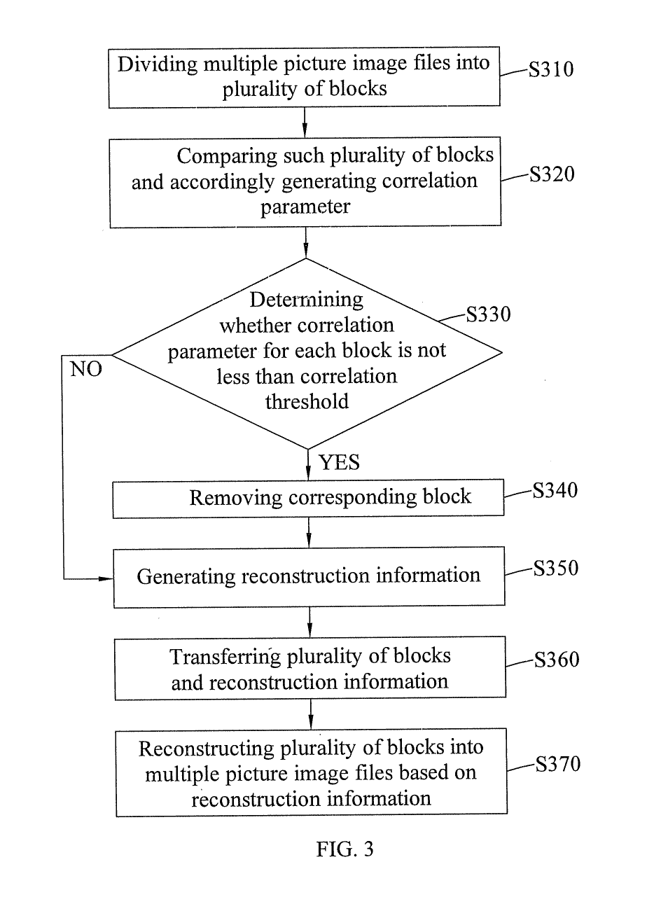

In addition to the application configuration illustrated as above, the picture image file transmission system and the method thereof according to the present invention is also applicable for the situation where multiple picture image files are to be transferred from the transfer end to the receive end. Such an application configuration differs from the aforementioned one in that, for the present application configuration, the transfer end and the receive end are not required to individually maintain a copy of the same block set data. Upon transferring the picture image files, the transfer end makes cross comparisons on the block data of the multiple picture image files, removes the block data of high correlation (i.e., after division, the blocks of high similarity among the plurality of block data need only to be sent once, thereby lowering the data transmission amount), and then transfers the block data after removal to the receive end, wherein the correlation of the block can be differently defined in accordance with actual applications; for example, color value of the block, brightness of the block or else other attributes applicable for differentiating block data and the like, and the level of the correlation (correlation threshold) may be also variably set depending on actual usage. Next, the receive end receives the block data and then reconstructs the received block data into the picture image files. The present configuration is applicable for transferring multiple picture image files as well as the directory of picture image files, and the time sequence relationship between such transferred multiple picture image files is not required. The method and the system described as above will now be further illustrated in details as below in conjunction with FIGS. 3 and 4.

Refer now to FIG. 3, wherein a flowchart for the method of picture image file transmission according to the present invention is shown. As depicted in the Figure, the method comprises the following steps: at STEP S310, dividing the multiple independent picture image files into a plurality of blocks at the transfer end, in which the multiple independent picture image files are preferably compressed files and the time sequence relationship between such multiple independent picture image files is not required; at STEP S320, comparing such plurality of blocks at the transfer end and accordingly generating the correlation parameter for each of the plurality of blocks; next, at STEP S330, determining whether the correlation parameter for each of the plurality of blocks is not less than the correlation threshold at the transfer end and removing the corresponding block, in which the correlation parameter not less than the correlation threshold, at STEP S340 in case of positive determination; subsequently, at STEP S350, generating a reconstruction information which records the linkage relationship between the plurality of blocks at the transfer end; next, at STEP S360, transferring the plurality of blocks those are not removed and the reconstruction information to the receive end; and finally, at STEP S370, reconstructing at the receive end the plurality of blocks into the multiple independent picture image files based on the reconstruction information.

Refer now to FIG. 4, wherein a diagram for the picture image file transmission system according to the present invention is shown. In the Figure, the picture image file transmission system as depicted comprises a transfer end 41 and a receive end 42. The transfer end 41 comprises a first database 411, a first image process module 412, a compare module 413, a process module 414 and a transfer module 415. The first database 411 can be used to store the correlation threshold 4112. The first image process module 412 can be used to divide the multiple independent picture image files into a plurality of blocks, wherein the multiple independent picture image files may be compressed files, and the time sequence relationship between such multiple independent picture image files is not required. The compare module 413 can be used to compare the plurality of blocks and accordingly generate the correlation parameter for each block. The process module 414 can determine whether a correlation parameter for each of the plurality of blocks is not less than a correlation threshold and remove the blocks having the correlation parameter not less than the correlation threshold 4112 from the plurality of blocks and accordingly generate a reconstruction information recording the linkage relationship between each of the plurality of blocks. The transfer module 415 can be used to transfer the plurality of blocks and the reconstruction information. The receive end 42 comprises a receive module 422 and a second image process module 423. The receive module 422 can be used to receive the plurality of block and the reconstruction data. The second image process module 423 can reconstruct the plurality of blocks into the multiple independent picture image files based on the reconstruction information.

Herein, before transferring the plurality of blocks those are not removed and the reconstruction information to the receive end 42, each of the blocks those are not removed is respectively compressed with a compression process, and the information of the compression process is transferred to the receive end 42. The receive end 42 performs decompressions on each of compressed blocks in accordance with the compression process respectively.

At the step of block comparing (or otherwise, the compare module 413) it is possible to determine the correlation parameter based on the brightness histogram for the plurality of blocks, and execute fast indexation on the brightness histogram for the block in terms of mean value of brightness, brightness variant or brightness variance.

The aforementioned descriptions are simply exemplary, rather than being intended as limiting. All effectively equivalent modifications or alternations made thereto without departing from the spirit and scope of the present invention are deemed as being included by the claims set forth hereunder.

What is claimed is:

1. A method of picture image file transmission for transferring a picture image file from a transfer end to a receive end, comprising the following steps of:
providing a first set of blocks at the transfer end and providing a second set of blocks at the receive end;
dividing the picture image file into a plurality of blocks at the transfer end;
comparing the plurality of blocks with the first set of blocks at the transfer end to generate a correlation parameter for each of the plurality of blocks;
determining at the transfer end whether the correlation parameter for each of the plurality of blocks is not less than a correlation threshold, and removing each of the blocks with the correlation parameter not less than the correlation threshold;
generating a reconstruction information at the transfer end, and the reconstruction information recording a linkage relationship between each of the plurality of blocks;
transferring the plurality of blocks those are not removed and the reconstruction information to the receive end; and
reconstructing the plurality of blocks into the picture image file based on the reconstruction information and the second set of blocks at the receive end.

2. The method of picture image file transmission according to claim 1, wherein the picture image file is a compressed picture image file.

3. The method of picture image file transmission according to claim 1, further comprising the following step of:
storing the plurality of blocks having the correlation parameter less than the correlation threshold into the first set of blocks and the second set of blocks at the transfer end and the receive end respectively.

4. The method of picture image file transmission according to claim 1, before the step of transferring the plurality of blocks those are not removed and the reconstruction information to the receive end, further comprising the following steps of:
compressing each of the plurality of blocks those are not removed, each with a compression process;
transferring information of the compression process to the receive end; and
decompressing each of the compressed blocks respectively by the receive end in accordance with the compression process respectively.

5. The method of picture image file transmission according to claim 1, further comprising the following steps of:
comparing the correlation parameter for each of the plurality of blocks based on a brightness histogram; and
executing fast indexations on the brightness histogram for each of the plurality of blocks in terms of mean value of brightness, brightness variant or brightness variance.

6. The method of picture image file transmission according to claim 1, wherein the first set of blocks and the second set of blocks have the same block data.

7. A method of picture image file transmission for transferring a plurality of picture image files from a transfer end to a receive end, comprising the following steps of:
dividing the plurality of picture image files into a plurality of blocks at the transfer end;
comparing the plurality of blocks at the transfer end to generate a correlation parameter for each of the plurality of blocks;
determining at the transfer end whether the correlation parameter for each of the plurality of blocks is not less than a correlation threshold, and removing each of the blocks with the correlation parameter not less than the correlation threshold;
generating a reconstruction information at the transfer end, and the reconstruction information recording a linkage relationship between each of the plurality of blocks;
transferring the plurality of blocks those are not removed and the reconstruction information to the receive end; and
reconstructing the plurality of blocks into the plurality of picture image files based on the reconstruction information at the receive end.

8. The method of picture image file transmission according to claim 7, wherein the plurality of picture image files are compressed picture image files.

9. The method of picture image file transmission according to claim 7, wherein no time sequence relationships exist between each of the plurality of picture image files.

10. The method of picture image file transmission according to claim 7, before the step of transferring the plurality of blocks those are not removed and the reconstruction information to the receive end, further comprising the following steps of:
compressing each of the plurality of blocks those are not removed, each with a compression process;
transferring information of the compression process to the receive end; and
decompressing each of the compressed blocks respectively by the receive end in accordance with the compression process respectively.

11. The method of picture image file transmission according to claim 7, further comprising the following steps of:
comparing the correlation parameter for each of the plurality of the blocks based on a brightness histogram, and
executing fast indexations on the brightness histogram for each of the plurality of blocks in terms of mean value of brightness, brightness variant or brightness variance.

12. A picture image file transmission system, comprising:
a transfer end, comprising:
a first database storing a first set of blocks and a correlation threshold;
a first image process module dividing a picture image file into a plurality of blocks;
a compare module comparing the plurality of blocks with the first set of blocks to generate a correlation parameter for each of the plurality of blocks;
a process module determining whether the correlation parameter for each of the plurality of blocks being not less than the correlation threshold and removing each of the blocks with the correlation parameter not less the correlation threshold and generating a reconstruction information, the reconstruction information recording a linkage relationship between each of the plurality of blocks; and
a transfer module transfering the plurality of blocks those are not removed and the reconstruction information, and
a receive end, comprising:
a second database storing a second set of blocks, the first set of blocks and the second set of blocks having the same block data;
a receive module receiving the plurality of blocks and the reconstruction information; and
a second image process module reconstructing the plurality of blocks into the picture image file based on the reconstruction information and the second set of blocks.

13. The picture image file transmission system according to claim 12, wherein the picture image file is a compressed picture image file.

14. The picture image file transmission system according to claim 12, wherein the plurality of blocks having the correlation parameter less than the correlation threshold are stored into the first set of blocks and the second set of blocks at the transfer end and the receive end respectively.

15. The picture image file transmission system according to claim 12, wherein each of the plurality of blocks those are not removed is compressed, each with a compression process before the transfer module transfers the plurality of blocks those are not removed, and the receive module receives information of the compression process and decompresses each of the compressed blocks respectively in accordance with the compression process respectively.

16. The picture image file transmission system according to claim 12, wherein the compare module compares the correlation parameter for each of the plurality of blocks based on a brightness histogram, and the compare module executes fast indexations on the brightness histogram for each of the plurality of blocks in terms of mean value of brightness, brightness variant or brightness variance.

17. A picture image file transmission system, comprising:
a transfer end, comprising:
a first database storing a correlation threshold;
a first image process module dividing a plurality of picture image files into a plurality of blocks;
a compare module comparing the plurality of blocks to generate a correlation parameter for each of the plurality of blocks;
a process module determining whether a correlation parameter for each of the plurality of blocks being not less than a correlation threshold and removing each of the blocks with the correlation parameter not less than the correlation threshold and generating a reconstruction information, the reconstruction information recording a linkage relationship between each of the plurality of blocks; and
a transfer module transfering the plurality of blocks those are not removed and the reconstruction information, and
a receive end, comprising:
a receive module receiving the plurality of blocks and the reconstruction information; and
a second image process module reconstructing the plurality of blocks into the plurality of picture image files based on the reconstruction information.

18. The picture image file transmission system according to claim 17, wherein the plurality of picture image files are compressed picture image files.

19. The picture image file transmission system according to claim 17, wherein no time sequence relationships exist between each of the plurality of picture image files.

20. The picture image file transmission system according to claim 17, wherein each of the plurality of blocks those are not removed is compressed, each with a compression process before the transfer module transfers the plurality of blocks those are not removed, and the receive module receives information of the compression process and decompresses each of the compressed blocks respectively in accordance with the compression process respectively.

21. The picture image file transmission system according to claim 17, wherein the compare module compares the correlation parameter for each of the plurality of blocks based on a brightness histogram, and executes fast indexations on the brightness histogram for the plurality of blocks in terms of mean value of brightness, brightness variant or brightness variance.
